(19) United States
(12) Patent Application Publication
(10) Pub. No.: US 2007/0151110 A1
(43) Pub. Date: Jul. 5, 2007

(54) Folding knife with improved blade retraction mechanism

(76) Inventor: Chia-Ying Chen, Sanchong City (TW)

Correspondence Address: BACON & THOMAS, PLLC, 625 SLATERS LANE, FOURTH FLOOR, ALEXANDRIA, VA, 22314, US

(21) Appl. No.: 11/305,046

(22) Filed: Dec. 19, 2005

(51) Int. Cl. B26B 3/06; F41B 13/02

(52) U.S. Cl. 30/155

(57) ABSTRACT

The present invention is to provide a folding knife having a handle and a blade pivotably provided at one end of the handle, wherein a sliding trigger is provided on an outer surface of the handle connecting a sliding block such that a sliding movement of the sliding trigger may move the sliding block, one end of a resilient member is urged by the sliding block, a resilient and elongate flat member is provided within the handle with one end formed as a latch slanted away from a pivot pin joining the blade and the handle. In a case of the blade pivoted out of the handle, the latch is obliquely urged against an edge of the blade proximate the pivot pin for prohibiting the blade from receiving in a groove of the handle. A sliding movement of one end of the sliding block can cause the latch to disengage with the blade, enabling the blade to pivot into the groove in a closed position.

### FIELD OF THE INVENTION

The present invention relates to folding knifes, and more particularly to a folding knife having a sliding trigger provided on an outer surface of a handle thereof and capable of being safely used by one hand of a user to disengage a latch with a blade pivotably provided at one end of the handle, enabling the blade to be folded into a groove in the handle.

### BACKGROUND OF THE INVENTION

Technology has known a rapid, spectacular development in the past several decades. Also, not only high technology products with continuing improvements are available but also commodities are improved constantly. Such improvements typically aim at raising products to a better quality by analyzing their drawbacks. Hopefully, the improvements can bring more convenience and comfort to our daily life.

Knifes have a wide variety of applications. For example, knifes are widely used by people engaged in leisure activities such as mountaineering, camping, or diving. Further, knives such as folding knives are commercially available for meeting the needs of outdoor activities. One type of folding knife is characterized in that it can be operated by one hand. In case of emergency, a user may quickly unfold the blade from the handle of the folding knife. For example, a diver may use one hand to quickly unfold the blade from the handle of the folding knife if unfortunately the other hand is tangled by fishing-net, rope, or safety belt in diving. Next, the diver may cut the fishing-net, rope, or safety belt by means of the cutting edge of the blade. As a result, life of the diver can be saved.

While such folding knife is characterized in that the blade can be quickly unfolded or folded by means of one hand, however, it lacks of safety due to its disadvantageous construction. For example, the finger of a user may be hurt by the cutting edge of the pivoting blade when the blade is folding into a groove in the handle. In a worse condition, the finger may be completely cut off. Thus, users must pay attention in using the folding knife. Also, folding knife manufacturers must spend time in developing an improved folding knife with safety feature. Following is a detailed description of the prior folding knife.

Referring to FIG. 1, the folding knife 1 comprises a handle 10 and a blade 20. The handle 10 comprises a groove 11 open to its lower side. The groove 11 is adapted to receive the folded blade 20. The blade 20 comprises a point 21 at one end, a pivotal member 22 at the other end, and a pivot pin 23 in the pivotal member 22 for pivotably disposing the pivotal member 22 at one end of the groove 11 in the handle 10. The blade 20 is adapted to receive in the groove 11 by pivoting the pivotal member 22 about the pivot pin 23. Alternatively, pivoting the pivotal member 22 about the pivot pin 23 will pivot the blade 20 out of the groove 11. Such pivoting will be stopped by a stopper 25 proximate the pivot pin 23 for preventing the blade 20 from pivoting out of its predetermined limit.

Moreover, a flat piece 13 is formed on one side of one plate adjacent the groove 11 in the handle 10. The flat piece 13 has one end extended from the pivot pin 23 toward the other end so as to form an elongate trough 14. A bent resilient member 15 is thus formed by the trough 14 and extended from one end of the flat piece 13 at the pivot pin 23. The resilient member 15 is adapted to bear against an outer surface of the pivotal member 22 of the blade 20 externally of the groove 11 (see FIG. 1).

Referring to FIG. 2, for retracting the blade 20 into the groove 11, a user has to press and flatten the resilient member 15 by means of the finger so as to disengage it with the outer surface of the pivotal member 22 of the blade 20. Next, pivot the back of the blade 20 to fold the blade 20 into the groove 11. However, the finger pressing the resilient member 15 (as indicated by arrow in FIG. 2) may be cut by the cutting edge of the retracting blade 20. To the worse, the finger may be completely cut off in an extreme condition. In brief, the folding knife 1 is not a safe device.

Thus, it is desirable among manufacturers of the art to provide a novel folding knife having advantages of being capable of easily, quickly folding or unfolding, being easy in carrying, and being highly safe when the blade is pivoting to retract into the handle, thereby contributing significantly to the advancement of the art.

### SUMMARY OF THE INVENTION

After considerable research and experimentation, a folding knife with an improved blade retraction mechanism according to the present invention has been devised so as to overcome the above drawback of the prior art. The drawback is that for retracting the blade into the handle, a user has to use the finger to press and flatten the bent resilient member prior to pivoting the blade into a closed position. However, the finger is susceptible of being cut by the cutting edge since the finger is approaching the cutting edge in the closing operation.

It is an object of the present invention to provide a folding knife with an improved blade retraction mechanism. The folding knife comprises a handle and a blade pivotably provided at one end of the handle. Thus, the blade is adapted to receive in an internal groove of the handle by pivoting about a pivot pin joining the handle and the blade. A resilient member and a sliding block are provided in the handle. A sliding trigger is provided on an outer surface of the handle connecting the sliding block such that a sliding movement of the trigger may move the sliding block. One end of the resilient member is urged by the other end of the sliding block. Further, a resilient, elongate flat member is provided within the handle. The other end of the flat member is fixedly fastened in the handle distal to the pivot pin joining the blade and the handle, and one end thereof is formed as a latch slanted away from the pivot pin joining the blade and the handle. In a case of the blade pivoted out of the handle, the latch is obliquely urged against an edge of the blade proximate the pivot pin for prohibiting the blade from receiving in the groove. The latch includes a projection formed on its surface facing the sliding block. The projection is in contact with one end of the sliding block. A sliding movement of one end of the sliding block can bend the projection to cause the latch to disengage with the blade. Thus, the blade is able to pivot into the groove in a closed position without pressing the latch. By utilizing this folding knife, the finger of a user is prevented from being hurt by the cutting edge of the pivoting blade when the blade is folding into the groove in the handle. As a result, the user may safely use the folding knife with one hand.

The above and other objects, features and advantages of the present invention will become apparent from the following detailed description taken with the accompanying drawings.

### BRIEF DESCRIPTION OF THE DRAWINGS

FIG. 1 is a perspective view of a conventional folding knife with the handle partially broken away and the blade unfolded for being ready for use;

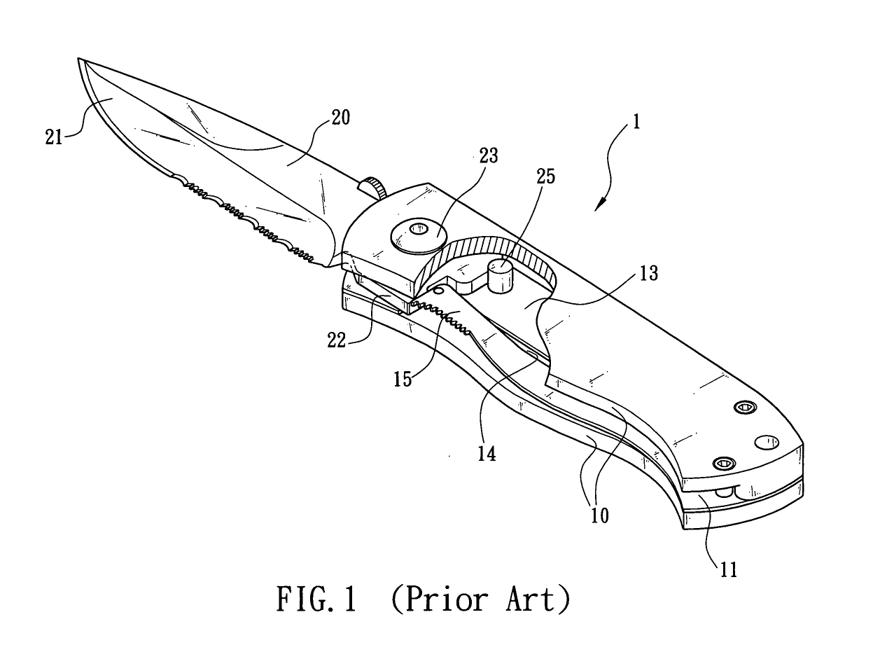

FIG. 2 is a schematic side view of the folding knife of FIG. 1 showing a pressing of the resilient member prior to folding the blade into the handle;

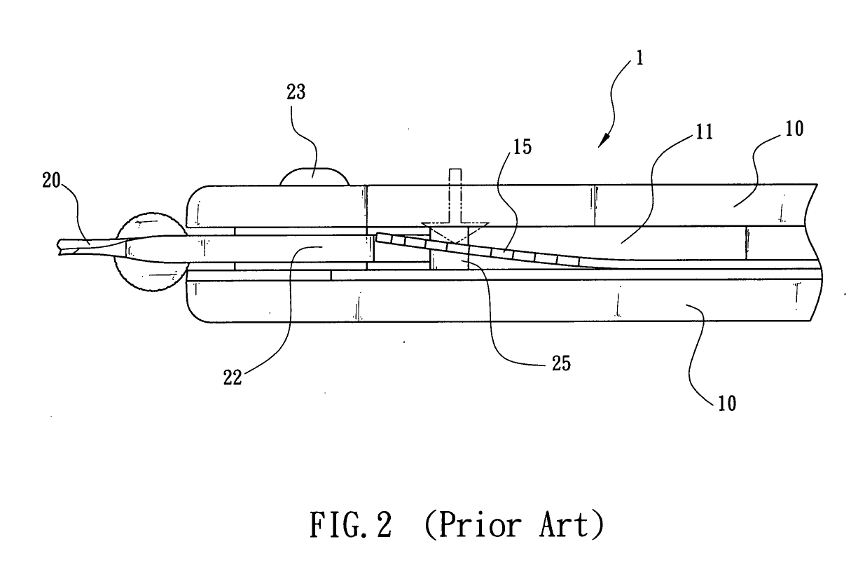

FIG. 3 is an exploded view of a first preferred embodiment of folding knife according to the invention;

FIG. 4 is a cross-sectional view of the assembled folding knife of FIG. 3 with the blade unfolded for being ready for use;

FIG. 5 is a view similar to FIG. 4 showing a folding operation of the blade of FIG. 3; and

FIG. 6 is an exploded view of a second preferred embodiment of folding knife according to the invention.

### DETAILED DESCRIPTION OF THE PREFERRED EMBODIMENTS

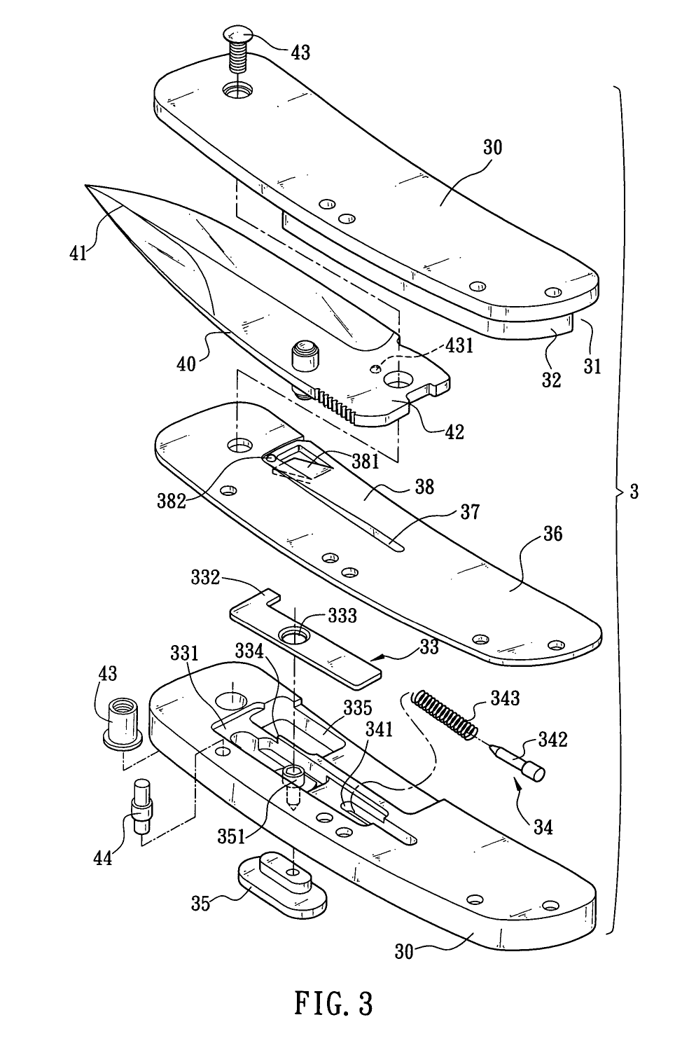

Referring to FIG. 3, there is shown a folding knife 3 according to a first preferred embodiment of the invention. The folding knife 3 comprises a handle 30 and a blade 40. The handle 30 comprises a groove 31 open to its lower side. The groove 31 is adapted to receive the folded blade 40. The blade 40 comprises a point 41 at one end, a pivotal member 42 at the other end, and a pivot pin 43 in the pivotal member 42 for pivotably disposing the pivotal member 42 at one end of the groove 31 in the handle 30. The blade 40 is adapted to receive in the groove 31 by pivoting the pivotal member 42 about the pivot pin 43. Alternatively, pivot the blade 20 out of the groove 31 until being stopped by a stopping rod 44 proximate the pivot pin 43 for preventing the blade 40 from pivoting out of its predetermined limit. In FIG. 3, the handle 30 comprises two identical plates coupled together by a small flat block 32 so as to form a gap (i.e., the groove 31) therebetween.

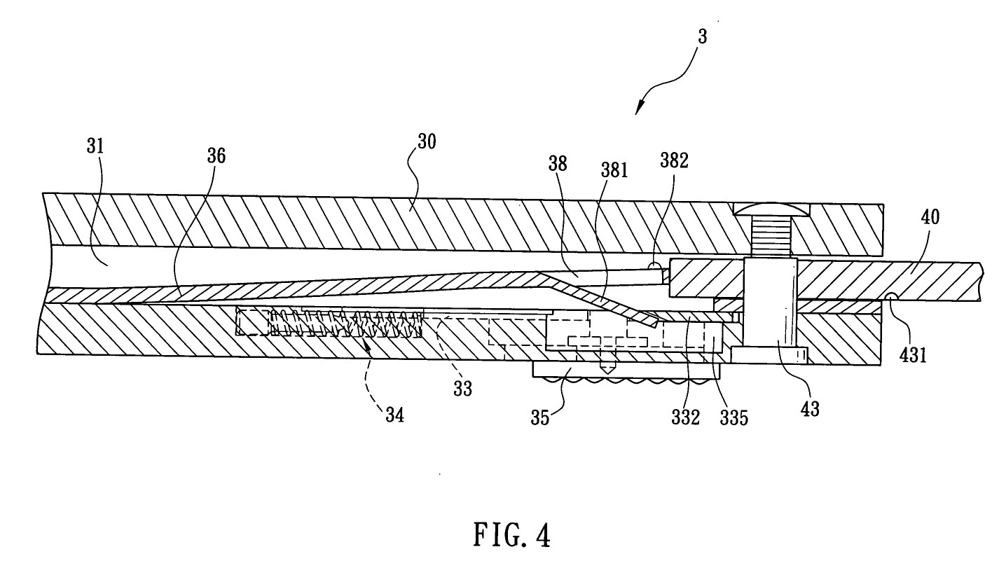

Referring to FIG. 3 again, in the invention on an inner surface of one plate of the handle 30 there are provided a rectangular recess 331 and an elongate trough 341 in communication therewith. A resilient member 34 is provided in the trough 341. The resilient member 34 comprises an elongate rod 342 and a helical spring 342 put on the rod 342. An elongate sliding block 33 is slidably provided in the recess 331. The other end of the sliding block 33 is urged by one end of the spring 343 distal to an enlarged head of the rod 342. One end of the sliding block 33 is formed as an extension (e.g., hook or protrusion) 332 perpendicular to the main body of the sliding block 33. The extension 332 is distal to the rod 342. A sliding trigger 35 is provided on an outer surface of the handle 30 connecting the sliding block 33. A sliding movement of the trigger 35 may cause the sliding block 33 to compress the spring 343 toward the other end of the rod 342. A release of the compressing force will cause the resilient member 34 to push the sliding block 33 to return to its original, inoperative position. Also, a resilient, elongate flat member 36 is provided within the handle 30 under the sliding block 33 and the resilient member 34. One end of the flat member 36 is pivotably secured to the pivot pin 43. An elongate slot 37 has its shorter portion proximate the one end of the flat member 36 and has its longer portion extended toward the other end of the flat member 36. A latch 38 is formed on the flat member 36 and is defined by the slot 37. As shown in FIGS. 3 and 4, the latch 38 has its open end slanting away from the blade 40. In a case of the blade 40 pivoted out of the handle 30, the latch 38 is obliquely urged against an outer surface of the pivotal member 42 of the blade 40 proximate the pivot pin 43 (i.e., at the pivot of the handle 30 and the blade 40). As an end, the blade 40 is prohibited from receiving in the groove 31.

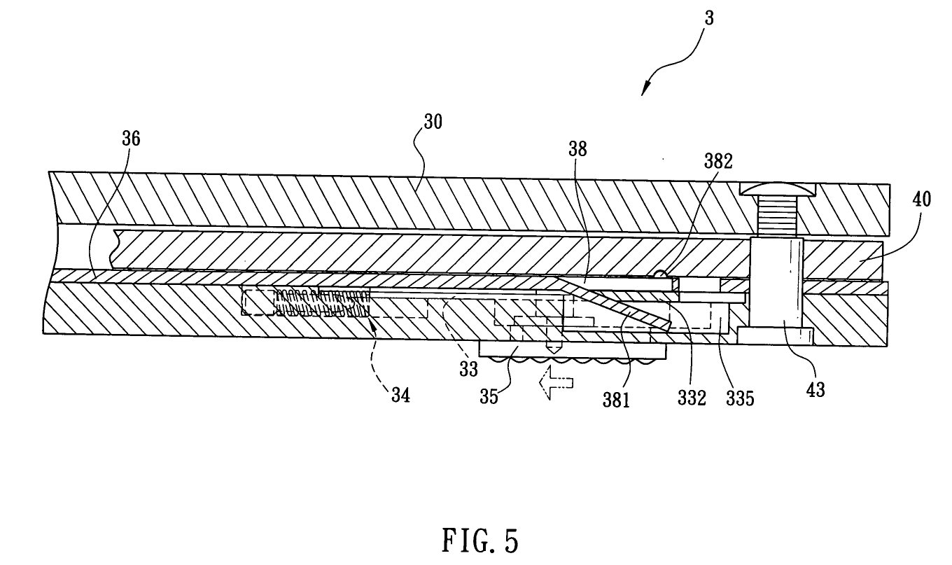

Referring to FIGS. 3 and 5, a projection 381 is formed proximate the open end of the latch 38 (i.e., proximate the pivot pin 43). The extension 332 is in contact with the projection 381 of the latch 38 and is urged against an underside of the projection 381. A sliding movement of the extension 332 can bend the projection 381 and thus the latch 38. In a case of the latch 38 contacted an edge of the blade 40, pivoting the blade 40 into the groove 31 will slide the trigger 35 to move the sliding block 33 and its extension 332 toward the resilient member 34 and compress the resilient member 34. Thus, the extension 332 bends the projection 381 to dispose further away from the blade 40. Thus, the latch 38 is not engaged with the edge of the blade 40. As a result, the blade 40 is able to pivot into the groove 31 (i.e., in a closed position).

Referring to FIG. 3 again, in addition a stopping wall 334 is formed in the recess 331 proximate the extension 332. The stopping wall 334 is adapted to prevent the extension 332 from moving excessively when the extension 332 contacts the projection 381 to move the latch 38. Otherwise, the projection 381 may deform or an angle between the projection 381 and the latch 38 is increased undesirably. A cavity 335 is formed in the handle 30 proximate the extension 332 and the recess 331. The cavity 335 is adapted to receive the projection 381 for protection. Otherwise, the projection 381 may deform in the handle 30 due to compression. Further, a through hole 333 is formed in the sliding block 33 and is adapted to allow a projecting bar 351 of the trigger 35 facing the sliding block 33 to pass. As a result, the sliding block 33 is fastened.

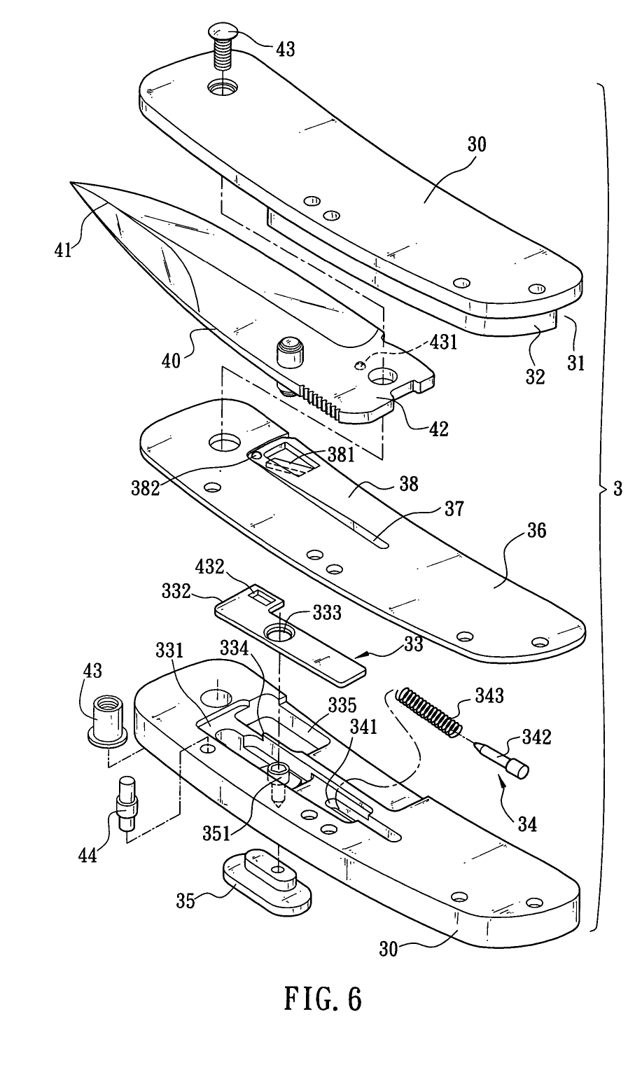

In the invention the provision of the extension 332 and the projection 381 aims at moving the latch 38 including the projection 381 away from the edge of the blade 40. Thus, the blade 40 is able to pivot into the groove 31 in a closed position. It is appreciated that a cooperating configuration of the extension 332 and the projection 381 is limited to the described one. Hence, either the extension 332 is configured as an element for hooking and moving the latch 38 or as an element being hooked by the latch 38 as long as the extension 332 is able to move the latch 38 out of engagement with the edge of the blade 40. For achieving the purpose, a second preferred embodiment of folding knife according to the invention is illustrated in FIG. 6. As shown, a rectangular opening 432 is formed in the extension 332 of the sliding block 33 facing projection 381. The projection 381 is able to insert into the opening 432. In a case of the sliding block 33 moved toward the resilient member 34 for compression, an edge of the sliding block 33 proximate the opening 432 may move toward the latch 38 along a surface of the projection 381. The projection 381 is thus urged by the extension 332 to bend the latch 38 toward the sliding block 33. Thus, the latch 38 is not engaged with the edge of the blade 40. As a result, the blade 40 is able to pivot into the groove 31 in a closed position.

Referring to FIGS. 3, 4, and 5 again, in the above embodiments of the invention an additional dimple 431 is provided on the blade 40 proximate the pivot pin 43. The provision of the dimple 431 can prevent the received blade 40 from pivoting out of the groove 31 of handle 30 to cause injury to the hand while carrying the folding knife 3. In detail, the dimple 431 is adapted to receive a protrusion 382 formed on a surface opposing the projection 381 but proximate the projection 381 when the blade 40 has received in the groove 31. By matingly engaging the protrusion 382 of the latch 38 with the dimple 431, the blade 40 is prevented from pivoting out the groove 31 when the blade 40 is urged by the latch 38.

While the invention herein disclosed has been described by means of specific embodiments, numerous modifications and variations could be made thereto by those skilled in the art without departing from the scope and spirit of the invention set forth in the claims.

What is claimed is:

1. A folding knife with a blade retraction mechanism, the folding knife comprising:
a blade including a point at one end and a pivotal member at the other end;
a handle including a groove open to a lower side, the groove being adapted to receive the folded blade wherein the pivotal member includes a pivot pin for pivotably disposing the pivotal member at one end of the groove, and the blade is adapted to either receive in the groove by pivoting in a first direction about the pivot pin or pivot out of the groove by pivoting in a second opposing direction about the pivotal member;
a resilient member provided in the handle facing the groove;
a sliding block provided in the handle and having the other end urged by one end of the resilient member, the sliding block including an extension formed at one end thereof distal to the resilient member;
a sliding trigger provided on an outer surface of the handle connecting the sliding block such that a sliding movement of the trigger is adapted to cause both the sliding block and the extension to move toward the resilient member; and
a latch provided within the handle wherein the other end of the latch is fixedly fastened in the handle distal to the other end of the blade, one end thereof is slanted away from the blade, and the latch includes a projection formed on its surface proximate the pivot pin, the projection being in contact with one end of the sliding block.

2. The folding knife of claim 1, further comprising an opening formed in the extension of the sliding block facing projection, wherein the projection is adapted to insert into the opening such that moving the sliding block toward the resilient member for compression will move an edge of the sliding block proximate the opening toward the latch along a surface of the projection to urge the projection for bending the latch toward the sliding block.

3. The folding knife of claim 1, further comprising a recess in the handle facing the groove for receiving the sliding block.

4. The folding knife of claim 2, further comprising a recess in the handle facing the groove for receiving the sliding block.

5. The folding knife of claim 1, further comprising a trough in the handle facing the groove for receiving the resilient member.

6. The folding knife of claim 2, further comprising a trough in the handle facing the groove for receiving the resilient member.

7. The folding knife of claim 1, further comprising a through hole formed in the sliding block and a projecting bar formed on the trigger facing the sliding block, wherein the through hole is adapted to permit the projecting bar to pass for fastening the sliding block.

8. The folding knife of claim 2, further comprising a through hole formed in the sliding block and a projecting bar formed on the trigger facing the sliding block, wherein the through hole is adapted to permit the projecting bar to pass for fastening the sliding block.

9. The folding knife of claim 1, wherein the resilient member comprises:
an elongate rod having an enlarged head; and
a helical spring put on the rod wherein the other end of the sliding block is urged by one end of the spring distal to the head of the rod.

10. The folding knife of claim 2, wherein the resilient member comprises:
an elongate rod having an enlarged head; and
a helical spring put on the rod wherein the other end of the sliding block is urged by one end of the spring distal to the head of the rod.

11. The folding knife of claim 1, wherein the handle comprises two identical, spaced plates and a flat block for coupling the plates together and for forming a gap therebetween as the groove.

12. The folding knife of claim 2, wherein the handle comprises two identical, spaced plates and a flat block for coupling the plates together and for forming a gap therebetween as the groove.

13. The folding knife of claim 1, further comprising a dimple formed on the blade proximate the pivot pin and a protrusion formed on the other surface of the latch opposing the projection, wherein of the dimple is adapted to receive the protrusion.

14. The folding knife of claim 2, further comprising a dimple formed on the blade proximate the pivot pin and a protrusion formed on the other surface of the latch opposing the projection, wherein of the dimple is adapted to receive the protrusion.

15. The folding knife of claim 1, further comprising a stopping wall formed in the recess proximate the extension.

16. The folding knife of claim 2, further comprising a stopping wall formed in the recess proximate the extension.

17. The folding knife of claim 1, further comprising a cavity formed in the handle proximate both the extension and the recess, wherein the cavity is adapted to receive the projection.

18. The folding knife of claim 2, further comprising a cavity formed in the handle proximate both the extension and the recess, wherein the cavity is adapted to receive the projection.

19. The folding knife of claim 1, wherein the extension is a hook.

20. The folding knife of claim 2, wherein the extension is a hook.

21. The folding knife of claim 1, wherein the extension is a protrusion.

22. The folding knife of claim 2, wherein the extension is a protrusion.
